(19) United States
(12) Patent Application Publication
(10) Pub. No.: US 2009/0159381 A1
(43) Pub. Date: Jun. 25, 2009

(54) HYDRAULICALLY ACTUABLE VEHICLE BRAKE HAVING A LOCKING MEANS

(76) Inventors: Kurt Mohr, Halsenbach/Ehr (DE); Manuel Schmitz, Herschbach (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/296,344

(22) PCT Filed: Apr. 3, 2007
(86) PCT No.: PCT/EP07/03008

§ 371 Date: Oct. 7, 2008

(30) Foreign Application Priority Data
Apr. 7, 2006 (DE) 10 2006 016 543.8

(51) Int. Cl. F16D 65/14

(52) U.S. Cl. 188/265

(57) ABSTRACT

The present invention relates to a vehicle brake (10) comprising a housing (12), a brake piston (16) accommodated in the housing (12) and coupled to a brake lining (20), a blocking device (26) for arresting the brake piston (16) inside the housing (12), and an electromechanical actuating device (42) for activating the blocking device (26) in a parking brake situation, wherein the brake piston (16) together with the housing (12) delimits a fluid chamber (68) that is chargeable with hydraulic fluid, so that the brake piston (16) for actuating the vehicle brake (10) is hydraulically displaceable inside the housing (12) along a piston longitudinal axis (A). In such a vehicle brake it is provided that there is associated with the blocking device (26) a locking arrangement (125), which in a parking brake situation acts mechanically on a component (36) of the blocking device (26) and locks the blocking device against a resetting movement.

### CROSS-REFERENCE TO RELATED APPLICATIONS

This application claims priority to International Patent Application No. PCT/EP2007/003008 filed Apr. 3, 2007, the disclosures of which are incorporated herein by reference in entirety, and which claimed priority to German Patent Application No. 10 2006 016 543.8 filed Apr. 7, 2006, the disclosures of which are incorporated herein by reference in entirety.

### BACKGROUND OF THE INVENTION

The present invention relates to a hydraulically actuable vehicle brake comprising a housing, a brake piston accommodated in the housing and coupled to a brake lining, a blocking device for arresting the brake piston inside the housing, and an electromechanical actuating device for activating the blocking device in a parking brake situation, wherein the brake piston together with the housing delimits a fluid chamber that is chargeable with hydraulic fluid so that the brake piston for actuating the vehicle brake is hydraulically displaceable inside the housing along a piston longitudinal axis.

Such a vehicle brake is already known. Thus, for example the genre-defining document DE 10 2004 040 261 A1 discloses a vehicle brake of this type. With this vehicle brake, in a service brake situation by charging the fluid chamber with hydraulic fluid the brake piston is displaced inside the housing and the brake lining is therefore pressed onto a rotating brake disk in order to brake this brake disk. To terminate the braking operation, hydraulic fluid is removed from the fluid chamber so that the brake piston with the brake lining attached thereto may move back into its normal position. In a parking brake situation, in which for example a vehicle equipped with such a vehicle brake is to be parked and prevented from unintentionally rolling away, the blocking device is actuated by means of an electromechanical actuating arrangement. The effect of this swivelling of the lever is that a ramp arrangement provided in the vehicle brake expands inside the housing and therefore executes a lifting movement in the direction of the piston longitudinal axis. This lifting movement is transmitted to a blocking element of the blocking device, which blocking element then presses upon the brake piston and axially displaces the brake piston counter to the action of a resetting spring. To cancel the parking brake situation, the fluid chamber and the actuating device are actuated again in the opposite direction, whereupon the ramp arrangement is displaced out of its expanded position back into its normal position. Under the action of the resetting spring the blocking element together with the brake piston is also displaced into its normal position, so that the brake lining releases the brake disk. With this background art it has emerged that it would be helpful to improve the mechanical arresting of the individual components in a parking brake situation in order to be able to eliminate unwanted setting operations.

In order to counteract the problems of high actuating forces that are in particular to be summoned up manually, the background art according to EP 0 551 397 D1 for example also discloses a hydraulically actuable vehicle brake, in which for activating the parking brake function first the brake piston is hydraulically displaced and then a blocking rod is electromotively driven until it contacts the brake piston. The blocking rod is provided with an external thread, which is in engagement with an internal thread provided in the housing. The mutually engaged threads are of a self-locking design, thereby preventing a mutual rotation between the blocking rod and the housing in the event of an axial force acting upon the blocking rod. As soon as the blocking rod contacts the brake piston, the hydraulic fluid is drained from the chamber. In this case, the brake piston attempts to move back into its normal position but is prevented from doing so by the fact that the blocking rod is resting against it. The brake is therefore in its parking brake position. To cancel the parking brake effect, the fluid chamber is again charged with hydraulic fluid so that the blocking rod is released from the brake piston. The blocking rod may then be moved back into its normal position by means of the electric motor and then the hydraulic fluid may be removed again from the fluid chamber. With this known arrangement a motorized activation of a parking brake effect is admittedly possible. However, this entails a relatively complicated bulky mechanism and correspondingly powerful electromotive components. A further reason for the provision of powerful components is in particular that the push rod has to be introduced into the pressurized fluid chamber and therefore has to be displaced against the hydraulic pressure prevailing in the fluid chamber.

As further background art the document DE 103 20 884 A1, and corresponding U.S. Pat. No. 7,316,300 B2, both of which are incorporated by reference herein, is to be cited, wherein the vehicle brake described there is a purely hydraulically actuable brake.

### BRIEF SUMMARY OF THE INVENTION

A problem of the present invention is to provide a vehicle brake of the initially described type that requires only low actuating forces to activate the parking brake function and guarantees a stable position of the components in a parking brake situation.

This problem is solved by a vehicle brake of the initially described type, in which there is associated with the blocking device a locking arrangement, which in a parking brake situation acts mechanically on a component of the blocking device and locks the blocking device against a resetting movement.

By virtue of providing a locking arrangement that directly acts mechanically on a component of the blocking device in a parking brake situation and hence locks the entire blocking device in the position associated with the parking brake situation, even better prevention of unintentional cancelling of the parking brake function is possible compared to the initially described genre-defining background art. By means of this measure, mechanical setting operations that may lead to an undesirable clamping force reduction may also be further reduced.

A development of the invention provides that the blocking device comprises a transmission element that is displaceable relative to the housing and relieves the blocking device upon actuation thereof relative to a fluid pressure prevailing inside the fluid chamber. By virtue of providing a transmission element that is displaceable in the housing, is accommodated at least partially in the fluid chamber and is loaded with the fluid pressure prevailing in the fluid chamber, with this development of the invention to utilize the fluid pressure prevailing in the fluid chamber to the effect that pressure-related counterforces, which counteract a displacement of the blocking device, may be at least partially compensated. In particular, in this connection according to the invention it may be provided that the transmission element has at least one hydraulically active pressure relief surface, which is pressurized by hydraulic fluid from the fluid chamber. The hydraulically active pressure relief surface in this case is preferably so disposed that, upon pressurization of the fluid chamber, it is loaded with pressure in such a way that the transmission element together with corresponding components of the blocking device is displaced in the direction of an arresting position of the blocking device or at least to facilitate such a movement relieves other components. As a result of this, the actuating device need summon up only low actuating forces to displace the blocking device for the purpose of arresting the brake piston inside the housing. The pressure relief surface is preferably formed on a piston head. A substantially complete pressure relief may be achieved for example in that the transmission element is at least indirectly pressurized on both sides of its, with regard to a displacement in the fluid chamber, hydraulically active surfaces with hydraulic fluid from the fluid chamber. The transmission element and, with it, the blocking device therefore behave in a pressure-neutral manner, so that only design-related friction forces need be summoned up to move the blocking device into a state in which the brake piston is locked.

To activate the blocking device it may be provided that the actuating device is motor-drivable or motor-driven by a rotary drive. A particularly simple and economical variant according to the invention arises for example if the drive takes the form of a rotary electromagnet, the actual position or/and power consumption of which is tappable as information about the function state of the vehicle brake in a parking brake situation. Such conventional rotary electromagnets are available at low cost but are capable of summoning up only low actuating forces. However, since—as already explained above—the invention allows a pressure-relieved actuation of the blocking device and so even low actuating forces are sufficient for actuating the blocking device, the use of such a rotary electromagnet of a conventional design is an advantageous option for realizing the vehicle brake according to the invention. As a result, the cost of manufacturing the vehicle brake may be considerably reduced and the brake as a whole may be of a compact design.

By tapping the actual position or/and power consumption it may be reliably established whether in fact a parking brake position that meets the requirements has been reached. It is therefore possible for example by means of associated electronic monitoring functions to detect a minimum power consumption or/and a minimum displacement, i.e. conditions that at least are to be met in order to be able to guarantee a specific minimum parking brake force. The minimum positioning displacement may be acquired for example by determining a minimum angle of rotation, wherein for this purpose a limit switch may be fitted on the rotary magnet arrangement. In principle, it is however also possible to acquire the actual angular position of the rotary magnet merely electronically. If in fact both parameters are monitored, i.e. the actual position and the power consumption, this provides double protection with regard to achieving a desired parking brake effect, thereby further increasing the operational reliability of the system.

A development of the invention provides a blocking element that acts upon the brake piston for the arresting thereof. The blocking element may then be displaced relative to the brake piston via further components of the blocking device in particular with the assistance of the transmission element.

In order to keep the distance to be traveled by the drive of the actuating device to a minimum, a development of the invention provides that the blocking element is drive-connected to the brake piston. This means that the blocking element during a hydraulic displacement of the brake piston is simultaneously driven by the brake piston, for example by means of a locking ring. It is only for the purpose of arresting the brake piston that it is then necessary to activate the blocking element actively via the actuating device—assisted by the transmission element. As a result, the time taken by the vehicle brake to respond to a command to activate the parking brake effect may be considerably shortened. This moreover offers advantages during the wear correction to keep the lifting clearance of the vehicle brake constant.

A development of the invention provides that the previously mentioned piston head carrying the pressure relief surface is guided in a fluid-proof manner in the blocking element. For this purpose, it may be provided that there is inserted into the blocking element a guide sleeve, in which the piston head is guided in a fluid-proof manner by means of a sealing element, in particular a lip seal. For example, a lip seal of the type fitted also in ABS pumps for the sealing of pressures above 200 bar may be used.

According to an embodiment of the invention it is provided that the blocking device comprises a ramp arrangement. The use of a ramp arrangement is generally known in the background art. It offers the advantage that the blocking element may be arrested by means of a simple, low-friction rotational movement of the actuating device, that furthermore the reaction forces resulting from the high clamping forces may be reliably removed into the housing, and that the vehicle brake is easily transferable with relatively little effort from a parking brake position back into a neutral position. A further advantageous aspect of the use of a ramp arrangement is that the rotational forces to be summoned up may be kept relatively low owing to the ramp-related mechanical advantage. This is again advantageous for the previously mentioned design of the drive as a rotary electromagnet, which—as already explained—is capable of summoning up only low actuating forces that lead to a torque of for example 2 Nm.

A development of this constructional variant provides that the ramp arrangement has at least one first ramp surface, which is provided on the housing or coupled in a rotationally fixed manner thereto, and at least one second ramp surface, which is formed on a ramp component that is axially displaceable relative to the housing and coupled to the blocking element, wherein upon actuation of the actuating device the two ramp surfaces slide off one another in order to displace the blocking element. To further reduce the actuating forces, in particular the friction forces that are to be overcome, according to the invention it may be provided that between the at least one first ramp surface and the at least one second ramp surface rolling bodies are provided, by which the at least one first ramp surface is in contact with the at least one second ramp surface.

Given construction of the vehicle brake according to the invention with a ramp arrangement, it may advantageously be provided that the ramp component is coupled to the transmission element and displaceable in a pressure-relieved manner inside the fluid chamber by means of the transmission element. Thus, the transmission element with its hydraulically active surface may be effective in such a way that owing to the hydraulic pressure prevailing in the fluid chamber it attempts to displace the ramp component in such a way that the ramp component pushes the blocking element into a position, in which it arrests the brake piston. Any hydraulically induced counterforces acting on the ramp component may therefore be reduced, compensated or even over-compensated. In the second and last-mentioned case, there are then in any case still friction forces to be overcome. In an advantageous manner, the cross section of the hydraulically active surface of the transmission element is tuned precisely to the cross section of the surface of the ramp component that is hydraulically active in the opposite direction, so that ideally a total compensation of the hydraulically induced counterforces may be achieved. In other words, with this solution according to the invention the hydraulic reaction forces acting on the transmission element and on the ramp component and caused by the fluid pressure of the fluid chamber cancel each other out. The coupling between the ramp component and the transmission element may be a fixed mechanical coupling. Equally, however, this coupling may alternatively provide only a common axial movement of these two components, wherein the two components are twistable relative to one another.

A development of the invention provides that the locking arrangement is designed with a locking organ that may be brought into interaction with the ramp component. In this case, it may for example be provided that the locking organ is biased by means of a biasing spring into the fluid chamber towards the ramp component into a locking position and by virtue of sufficient pressurization upon charging of the fluid chamber with hydraulic fluid is displaceable out of the locking position into a release position when a minimum pressure value is exceeded. The locking organ may therefore be hydraulically actuated and reacts to the fluid pressure actually prevailing in the fluid chamber. The locking arrangement therefore switches automatically into the release position upon attainment of a specific minimum pressure and hence enables a cancelling of the parking brake function. If the hydraulic fluid pressure prevailing in the fluid chamber falls below this minimum pressure, then under the action of the biasing spring the locking organ is displaced back into its locking position, this in a parking brake situation leading to a stable retention of the blocking device and in a service brake situation moreover being safe because in the service brake situation the brake piston is displaced in any case purely hydraulically.

As an alternative to the design of a purely hydraulically actuated locking arrangement, it may further be provided that the locking organ is biased by means of a magnet arrangement into the fluid chamber towards the ramp component in a locking position and by virtue of actuation of the magnet is displaceable out of the locking position into a release position. In the case of this constructional variant, in the fluid chamber there is for example a pressure acquisition, wherein in accordance with the actually acquired pressure with due regard to the operator input request of the driver, i.e. in dependence upon whether or not the driver would like to activate the parking brake, an activation of the magnet arrangement and hence an actuation of the locking organ is effected.

According to a constructional variant it is provided that the locking organ takes the form of a friction element that may be brought with a friction surface into frictional abutment with a complementary friction surface of the ramp component. In this form of construction, the ramp component is held in its actual position solely by means of sufficiently high friction forces. As an alternative thereto, a preferred form of construction of the invention however provides that the locking organ takes the form of a catch element that may be brought with a locking profile into engagement with a complementary locking profile of the ramp component. Instead of the previously outlined frictionally engaged blocking of the ramp component, in this constructional variant a keyed blocking of the ramp component is provided. This provides even better protection against unintentional, wear- or fouling-related slipping. Thus, for example it may be provided that the locking profile comprises at least one detent tooth and that the complementary locking profile comprises a corresponding saw-tooth formation that is disposed preferably on a circumferential surface of the ramp component. For blocking, the at least one detent tooth may then be brought into engagement with the saw-tooth formation. A saw-tooth formation ensures particularly reliable engagement of the locking profile and complementary locking profile.

As regards the mode of operation of the vehicle brake according to the invention, it may be provided that in a service brake situation the brake piston is displaceable inside the housing by charging the fluid chamber with hydraulic fluid and emptying the fluid chamber and that in a parking brake situation first the brake piston is displaced inside the housing by charging the fluid chamber with hydraulic fluid, then the electromechanical actuating device is actuated to arrest the brake piston, wherein the transmission element moves towards the brake piston, then the locking arrangement is activated and finally for a pressure reduction in the fluid chamber hydraulic fluid is removed from the fluid chamber. Thus, for activating the parking brake function the clamping force, which is summoned up by a hydraulic actuation and displacement of the brake piston, may be utilized to apply and clamp the brake lining onto the brake disk. The brake lining therefore does not have to be additionally fed onto the brake disk by the drive of the vehicle brake according to the invention, thereby—as already explained several times above—allowing the drive to be of a low-capacity and hence economical design. The activation of the locking arrangement in the state of maximum fluid pressure inside the fluid chamber ensures that the blocking device is blocked precisely when the maximum parking brake force is attained. The subsequently arising setting operations are minimal, this leading, especially in the case of a keyed locking arrangement, to very high retention forces during the parking brake situation, i.e. after reduction of the fluid pressure in the fluid chamber.

To cancel the parking brake situation, in the case of the previously described variant it is possible to re-charge the fluid chamber with hydraulic fluid in order thereby to cancel a mechanical coupling between brake piston and blocking device. The locking arrangement is consequently transferred to a state, in which it releases the blocking device. The actuating device may then be correspondingly activated and may with low actuating forces return the blocking element to its normal position, in which it in turn releases the brake piston. This occurs once again in a pressure-relieved manner through the action of the transmission element. Hydraulic fluid may then be removed from the fluid chamber again, so that the brake piston may move back into a braking-effect-free normal position.

The invention further relates to a method of actuating a vehicle brake of the previously described type, wherein in a service brake situation the brake piston is displaced inside the housing in that hydraulic fluid is fed to the fluid chamber or removed from the fluid chamber, and that in a parking brake situation first the brake piston is displaced inside the housing by charging the fluid chamber with hydraulic fluid, then the electromechanical actuating device is actuated to arrest the brake piston, wherein the transmission element moves towards the brake piston, then the locking arrangement is activated, and finally for a pressure reduction in the fluid chamber hydraulic fluid is removed from the fluid chamber.

In the method according to the invention it may further be provided that for cancelling the parking brake situation the fluid chamber is charged with hydraulic fluid, then the locking arrangement and the blocking device are released and finally for a pressure reduction in the fluid chamber hydraulic fluid is removed from the fluid chamber.

In the method according to the invention it may further be provided that the blocking device is actuated by a rotary electromagnet, the actual position or/and power consumption of which is tapped as information about the function state of the vehicle brake in a parking brake situation.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a longitudinal sectional view of a first embodiment of the vehicle brake according to the invention;

FIG. 2 is a sectional view along cutting line II-II of FIG. 1;

FIG. 3 is a sectional view as in FIG. 1 of a second embodiment of a vehicle brake according to the invention;

FIG. 4 is a sectional view along cutting line IV-IV of FIG. 3;

FIG. 5 is a diagrammatic overview representation relating to the second embodiment with the diagrammatically shown hydraulic circuit, and

FIG. 6 is a flowchart illustrating the actuation of the vehicle brake according to the invention in a parking brake situation.

### DETAILED DESCRIPTION OF THE INVENTION

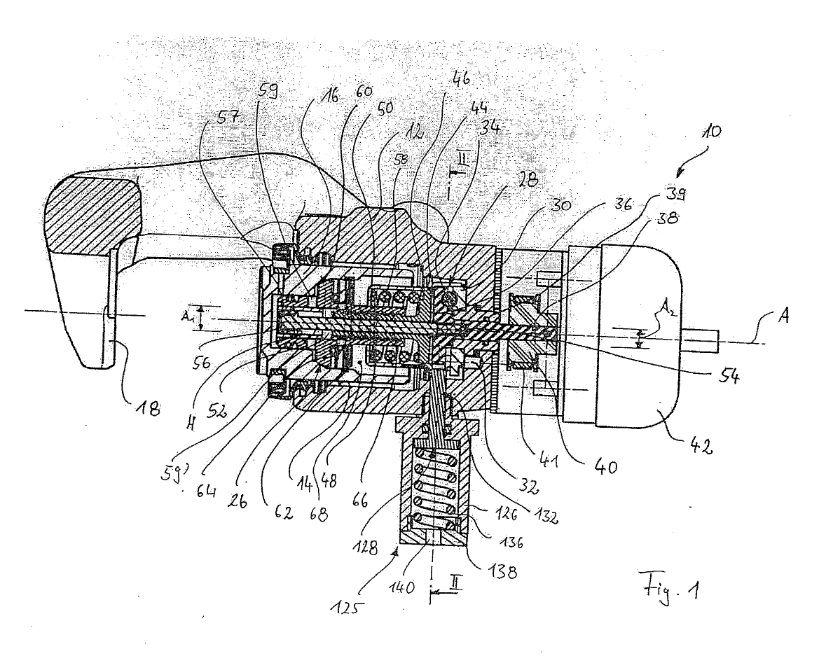

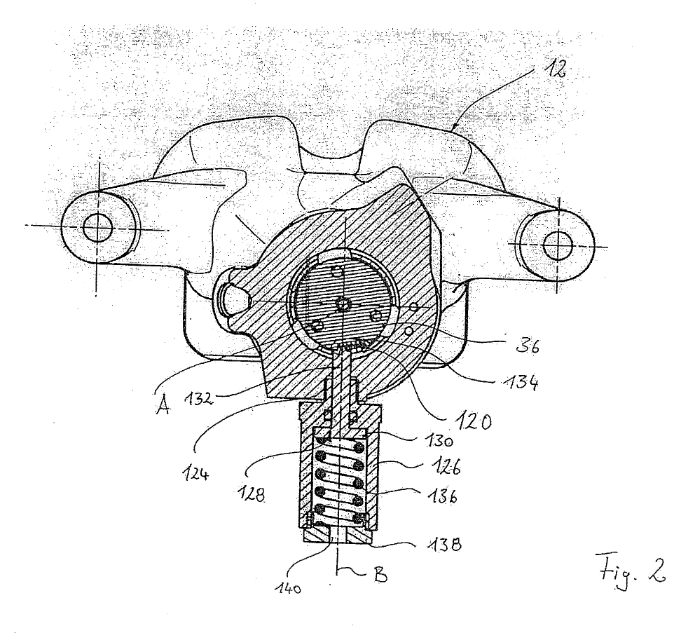

First, the first embodiment is described below with reference to FIGS. 1 and 2.

In FIG. 1 a vehicle brake according to the invention is generally denoted by 10. It is designed with a housing 12, which has a cylindrical opening 14. In the cylindrical opening 14 a brake piston 16 is accommodated displaceably in a fluid-proof manner. The brake piston 16 at its, in FIG. 1 left, end is mechanically connectable to a brake lining carrier (not shown), to which a brake lining is fastenable. Lying opposite the brake lining is a further brake lining, which is fastened to a housing part 18 lying opposite. The brake linings are accommodated in the housing 12 in a conventional manner based on the floating caliper principle.

The vehicle brake 10 further comprises a blocking device 26, by means of which the brake piston 16 may be arrested in various axial positions along the piston longitudinal axis A. The blocking device 26 in the first embodiment comprises a ramp arrangement 28 having a ramp disk 30, which is fixed by means of a bolt 32 to the housing 12. Formed on the housing-fixed ramp disk 30 are three trough-like ramps extending in circumferential direction and each accommodating a ball-shaped expansion body 34. The expansion bodies 34 each interact with a corresponding ramp of a ramp component 36. This ramp component 36 comprises a shaft attachment 38, which is rotatably mounted in a sealed manner in the housing 12. The shaft attachment 38 is accommodated in a bearing bush 39, which is accommodated sealingly by means of an additional O-ring seal on its outer circumference in the housing 12. The bearing bush 39 further comprises on its inner circumference an O-ring seal, which sealingly accommodates the shaft attachment 38. The bearing bush 39 is preferably manufactured from a copper-zinc wrought alloy so that it has very good sliding properties. Adjoining the shaft attachment 38 and coupled in a rotationally fixed manner thereto is a gearwheel 40, which may be set via a toothed belt 41 in rotation about the longitudinal axis A by a rotary magnet arrangement 42. Because of the rotationally fixed connection of the gearwheel 40 and the shaft attachment 38 the ramp component 36 may therefore be set in rotation about the piston longitudinal axis A.

Against the side of the ramp component 36 facing the brake piston 16 a support component 46 is supported via a plain bearing 44 or alternatively a rolling-contact bearing, in particular a needle-roller assembly. The support component 46 is therefore twistable about the piston longitudinal axis A with low friction relative to the ramp component 36. The support component 46 is biased towards the ramp component 36 by means of a compression spring 48. The compression spring 48 is supported by its one end against the biased. The compression spring 48 is supported by its one end against the large-diameter flange of the support component 46 and by its other end against the base of a housing-fixed cup 50.

The support component 46 is designed with an axial through-hole, in which a shank of a transmission element 52 is displaceably accommodated, the shank in order to reduce weight and gain additional pressure compensation surface being of a relatively thin design. The transmission element 52 is connected by its brake-piston-remote end at 54 to the ramp component 36, for example is screwed into the ramp component (thread M4) or connected in some other way for joint axial movement, but so as to be twistable relative to one another. On its end facing the brake piston the transmission element 52 has a piston head 56. The piston head 56 is accommodated by means of a sealing lip element sealingly in a guide sleeve 57, which is press-fitted into a blocking element 58. The guide sleeve 57 is dimensioned in such a way that it terminates flush with the, in FIG. 1 left, end of the blocking element 58 and contacts the, in FIG. 1 left, end of the support component. The blocking element 58 in turn is displaceably guided in the brake piston 16. It has radial bores 59 and 59′ that allow a fluidic connection into its centre for pressurizing the piston head 56. It further has at 60 a conical flange that may be brought into engagement with a corresponding internal taper on the brake piston 16.

The blocking element 58 may be driven via a locking ring 62 and a spring washer 64 upon a movement of the brake piston 16 in FIG. 1 to the left. It should further be noted that the blocking element 58 is coupled to the support component 46 threadwise by a steep-lead-angle thread pairing 66, which has a precisely defined thread backlash. This steep-lead-angle thread pairing 66 is preferably so designed that the rotary magnet arrangement 42 for the arresting is rotated through a specific angle of rotation.

It should additionally be noted that the surface A₁ of the piston head 56 is designed to be as least as great as the surface A₂ of the shaft attachment 38 sealingly guided in the housing, which surface A₂ does not lie in a fluid chamber 68 and therefore also does not come into contact with hydraulic fluid. Thus, upon filling of the fluid chamber denoted in the figures by 68, the assembly group composed of ramp component 36 and transmission element 52 is relieved of pressure. In other words, all of the reaction forces arising as a result of the hydraulic pressure applied to this assembly group are compensated, this being attributable in particular to the effect of the hydraulically active surface H of the guide flange 56 facing the fluid chamber 68.

Referring now also to FIG. 2, this shows a locking arrangement according to FIG. 1 in a section orthogonal to the axis. In FIG. 2 it is evident that the ramp component 36 is provided on its outer circumference with gearing 120. It is further evident that there is incorporated into the housing 12 an internally threaded locating hole 124, into which a cartridge 126 is screwed. The cartridge 126 is of a hollow-cylindrical design. In it a locking organ 128 is guided displaceably in the direction of a transverse axis B orthogonal to the longitudinal axis A. The locking organ comprises a flange 130 and a shank 132. On the end of the shank 132 remote from the flange gearing 134 corresponding to the gearing 120 is provided. The two gearings 120 and 134 take the form of a saw-tooth profile.

In FIGS. 1 and 2 it is further revealed that the flange 130 is biased by a helical compression spring 136 into the position shown in FIGS. 1 and 2, in which the two gearings 120 and 134 mesh with one another. At the end of the helical compression spring 136 remote from the flange there is screwed into the cartridge 126 a retaining element 138, against which the helical compression spring 136 is supported. The retaining element 138 has a central opening 140 to allow venting of the interior of the cartridge 126 in the event of a movement of the locking organ 128.

As is evident both from FIG. 1 and from FIG. 2, the shank 132 acts as a kind of piston, which upon pressurization of the fluid chamber 68 is displaceable in FIG. 2 down along the transverse axis B counter to the action of the helical compression spring 136. The spring 136 is so designed that over a large pressure range it withstands such a displacement but from a specific minimum pressure allows a corresponding displacement and is then compressed. The minimum pressure may be ca. 160 bar.

As an alternative to the illustrated design having a compression spring, it is also possible to replace the helical compression spring 136 with an actuating magnet arrangement, which displaces the locking organ 128 in a pressure-dependent manner, for example when the previously mentioned minimum pressure is exceeded.

The vehicle brake 10 according to FIGS. 1 and 2 operates as follows:

In a service brake situation, in which a rotating brake disk provided between the brake linings but not shown in the figures is to be braked, the fluid chamber 68 is charged with hydraulic fluid and so the brake piston 16 is displaced inside the housing 12. So long as this displacement is not greater than the thread backlash, which exists in the steep-lead-angle thread pairing 66 between the support component 46 and the blocking element 58 and corresponds to the provided brake lifting clearance, the blocking element 58 moves entirely simultaneously with the brake piston 16.

If however as a result of wear of the brake linings a displacement of the brake piston 16 that exceeds the provided brake lifting clearance is needed to apply the non-illustrated brake linings against the non-illustrated brake disk, then the compression spring 48 prevents the support component 46, upon hydraulic actuation, from participating in the entire displacement of the brake piston 16 towards the brake disk. As a result, the conical flange 60 of the blocking element 58 is lifted slightly off the internal taper against the resistance of the spring washer 64, which is weaker than the bias of the compression spring 48. The blocking element 58 is therefore no longer prevented from rotating about the axis A.

The axial force, which is transmitted by the steep-lead-angle thread pairing 66 and with which the support component 46 attempts to restrain the blocking element 58 counter to the action of the spring 64, has a peripheral component. This gives rise to a torque, by means of which the blocking element 58 is then rotated in such a way that it unscrews from the support component 46. The conical flange 60 consequently moves once more into abutment with the internal taper of the brake piston 16. As the effective length of the assembly group formed by the support component 46 and the blocking element 58 is then increased, the brake piston 16 after the brake actuation is prevented from returning fully into its original normal position. The brake lifting clearance has therefore been reduced back to its setpoint value.

If in the event of a powerful hydraulic brake actuation inside the fluid chamber 68 a pressure of for example 20 bar or more arises, elastic deformations are inevitable particularly in the region of the brake linings and the housing 10. A correction that would compensate such temporary deformations is undesirable and is therefore prevented as follows: the pressure in the fluid chamber 68 acts also upon the blocking element 58. In the event of powerful hydraulic actuation, the axial forces exerted by the spring washer 64 and by the hydraulic pressure on the blocking element 58 are as a whole greater than the force exerted by the compression spring 48 on the brake-piston-remote flange of the support component 46. The compression spring 48 is therefore no longer able to hold the support component 46 fast. As a result, the conical flange 60 is unable to lift off the internal taper. The blocking element 58 is therefore prevented from rotating, so that the brake actuation occurs without correction. It is only if the hydraulic pressure has dropped below the said threshold value of for example 20 bar that it is possible to retrieve a correction, should this have become necessary as a result of advanced lining wear of the brake linings.

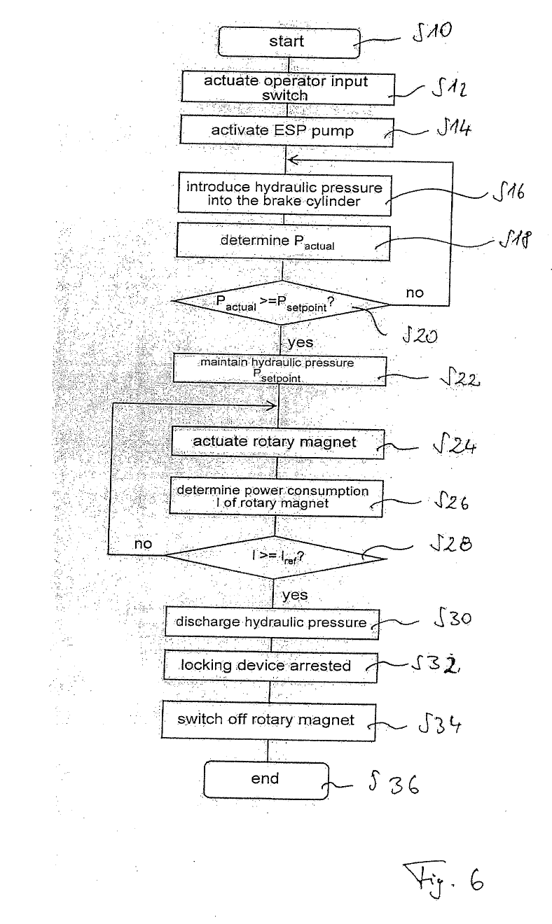

The following description relates to the activation of the parking brake function of the vehicle brake 10 according to the invention, the purpose of which function is to lock the brake disk provided between the brake linings against unintentional rotation. To explain the parking brake function, reference is made additionally to FIGS. 2 and 6.

To actuate the vehicle brake 10 in a parking brake situation in response to actuation of a switch disposed in the vehicle interior (step S12 in FIG. 6), an ESP pump is activated and first of all hydraulic fluid is fed to the fluid chamber 68 and the fluid pressure prevailing therein is increased from a value of for example 0 bar to a value of for example 200 bar. The hydraulic fluid may be fed as a result of actuation of the brake pedal by the driver or automatically independently of, or in addition to, a brake pedal actuation by means of a pump in a similar manner to an automatic braking operation, for example by means of an ESP, for example controlled by means of an ECU 90. In this case, control valves are operated by the ECU (FIG. 6, step S14-S18). The result is a clamping force at the brake linings. By virtue of such pressurization—as already described above—the blocking element 58 is held in abutment with the brake piston 16. The blocking element 58 by means of the steep-lead-angle thread pairing pulls the support component 46 along so that a small gap arises between the ramp component 36 and the thrust bearing 44. This small gap is for example two to three millimetres. The thrust bearing 44 in this case is held exclusively on the shank of the transmission element 52.

The pressure in the fluid chamber 68 is subsequently—if one disregards setting operations—substantially maintained (step S22). Because of the filling of the fluid chamber 68 with hydraulic fluid in a pressure range that lies markedly above the previously indicated minimum pressure for compression of the helical compression spring 136, the locking organ 128 has been pressure-dependently displaced out of the fluid chamber 68, with simultaneous compression of the helical compression spring 136, into the interior of the cartridge 126. This means that the gearing 134 on the radially inner end of the locking organ 128 is no longer in mesh with the gearing 120 on the circumferential region of the ramp component 36.

Once this state is reached, the electronic control unit then activates the rotary magnet arrangement 42. This arrangement via the toothed belt 41 and the gearwheel 40, which has been set in rotation, drives the ramp component 36 so that the latter rotates about the axis of rotation A and is displaced because of an expansion movement caused by the rolling bodies 34 and the ramp surfaces in axial direction in FIG. 1 to the left relative to the ramp disk 30.

One aspect of the invention is that this movement of the ramp component 36 may be realized with very low actuating forces. This is because the hydraulically active surface H of the piston head 56 of the transmission element 52 that is permanently coupled to the ramp component 36 compensates the hydraulic counterforces that would counteract a movement of the ramp component 36 into the fluid chamber 68. By virtue of suitable dimensioning of the piston head 56 and correspondingly small dimensioning of the diameter of the shank 52 it is even possible to realize an over-compensation of the hydraulic counterforces, so that an expansion movement of the ramp arrangement 20 may be promoted.

The counterforce compensation effect arises particularly if the surface A₁, which is hydraulically inactive (and therefore to be compensated), of the shaft attachment 38 is greater than or equal to the surface A₂ of the guide flange 56. To put it more precisely, the small-dimensioned, hydraulically inactive cross-sectional area of the shank of the transmission element 52 would still have to be deducted from both surfaces. Given such a surface equality A₁≧A₂, the relationship applies that the reaction forces F₁ and F₂ arising on account of the hydraulic pressure prevailing in the fluid chamber 68 are likewise equal and therefore cancel each other out.

According to the invention this principle is used to design the rotary magnet arrangement 42 with as low a capacity as possible and thereby achieve cost savings in parts procurement and a reduction in installation space. Very low actuating forces are sufficient to displace the ramp component 36 over the previously discussed gap by virtue of an expansion relative to the ramp disk 30 in the direction of the axis A until the ramp component once more abuts the plain bearing.

The fluid pressure in the fluid chamber 68 is then reduced (step S30). At the start of this pressure reduction, at first nothing happens. However, once the pressure drops below the limit pressure that is crucial for the compression of the helical compression spring 136, this spring may expand and push the locking organ 128 into the fluid chamber 68 until it reaches its end position. In this position the locking organ 128 engages with its gearing 134 into the gearing 120 on the circumference of the ramp component 36 and fixes the latter in its angular position. This occurs automatically during the reduction of the fluid pressure in the fluid chamber 68. As a result of a continued pressure reduction the brake piston 16 attempts to move back, in FIG. 1 to the right, but is supported via the blocking element 58, the support component 56 and the plain bearing 44 against the ramp component 36, which has been displaced in FIG. 1 to the left and which in turn is supported via the rolling bodies 34 against the housing-fixed ramp disk 30 and locked against rotation by means of the intermeshing gearings (step S32). There is at most a minimal resetting movement on account of setting operations, which is however negligibly small, so that the remaining clamping force is still high enough, even after complete reduction of the hydraulic pressure in the fluid chamber 68, to still be able to maintain an adequate clamping effect that is sufficient to lock the brake disk against unintentional rotation. Finally, the rotary magnet arrangement 42 may be switched off (step S34). The locking operation and the pressure relief should occur advantageously almost in synchronism in order to rule out any losses in the clamping force.

To cancel the parking brake function after corresponding actuation of the switch 96, the hydraulic pressure in the fluid chamber 68 is increased again until it reaches the previously mentioned value of for example 200 bar. As a result, the clamping force also slightly increases until it finally reaches substantially the previously mentioned maximum clamping force value, at which the support component 46 was in turn displaced slightly by the ramp component 36 in FIG. 1 to the left. During the increasing of the fluid pressure in the fluid chamber 68, when the limit pressure crucial for the compression of the helical compression spring 136 is exceeded, the locking organ 128 is displaced once more into the cartridge 126 and releases the ramp component 36 for a rotational movement. An activation of the rotary magnet arrangement 42 then occurs, so that the ramp component 36 itself may be shifted back into its normal position by the low resetting forces of the rotary magnet arrangement 42. Hydraulic fluid is subsequently removed from the fluid chamber 58, thereby allowing the fluid chamber to empty and the brake piston 16 to return to its normal position shown in FIG. 1.

With the first embodiment of the invention it is therefore possible to provide a reliable parking brake function, which because of the action of the locking arrangement 125 prevents unintentional cancellation and which by virtue of utilizing the hydraulic pressure in the fluid chamber and by virtue of the previously discussed counterforce compensation or over-compensation requires only very low actuating forces via the rotary magnet arrangement 42. The rotary magnet arrangement 42 may be designed with a correspondingly low capacity.

It should further be noted that a function check and/or function monitoring may be carried out by monitoring specific operating parameters of the rotary magnet arrangement 42. Such operating parameters may be for example the power consumption and the angle-of-rotation position of the rotary magnet arrangement 42, which are easy to monitor and which reliably with a safety-enhancing redundancy provide information about the actual state of the brake. From this information it is also possible to determine whether the latching by means of the two gearings 120 and 134 has not occurred too early before attainment of a position that guarantees a parking brake effect.

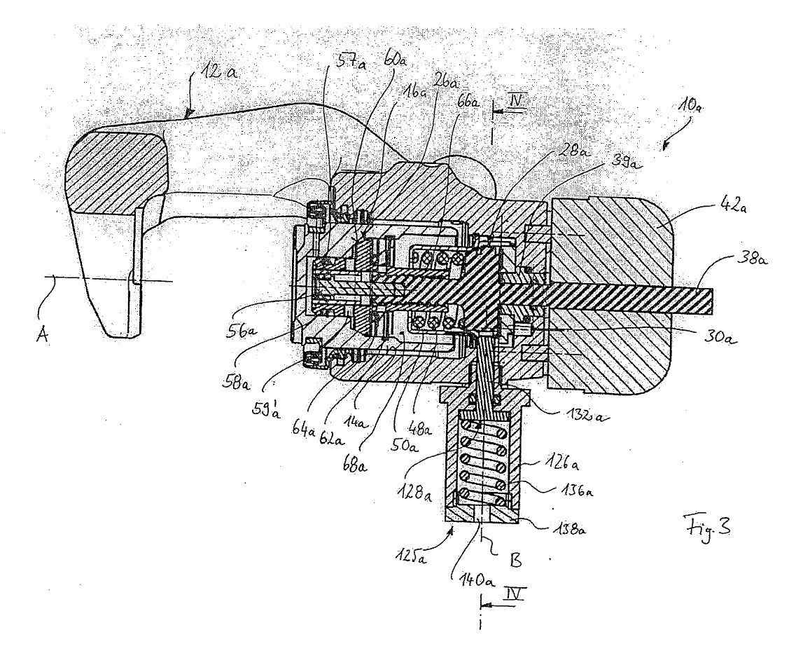

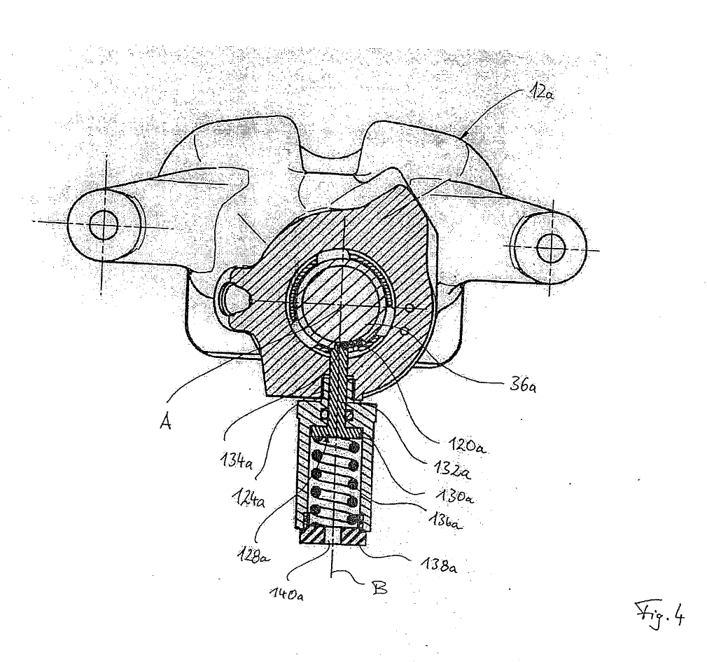

FIGS. 3 and 4 show a second embodiment of the invention. To avoid repetition and simplify the description the following description relates only to the differences of the second embodiment according to FIGS. 3 and 4 from the first embodiment according to FIGS. 1 and 2. For components of an identical effect or identical type the same reference characters as in the description of the first embodiment are used, but with the lower-case letter “a” appended.

The second embodiment according to FIGS. 3 and 4 differs from the first embodiment according to FIGS. 1 and 2 in the design of the rotary magnet. This takes the form of a push-pull electromagnet and has a ball ramp plane that converts an integrated linear movement of the electromagnet to a rotational movement. This rotational movement is transmitted to the shaft attachment 38a, wherein the previously described effects arise. The linear displacement along the longitudinal axis A is therefore achieved directly by the lifting movement of the magnet arrangement 42a.

Otherwise, the arrangement according to FIGS. 3 and 4 operates precisely as described above with reference to FIGS. 1 and 2. In particular, the locking arrangement 125a operates pressure-dependently, as described above with regard to the locking arrangement 125.

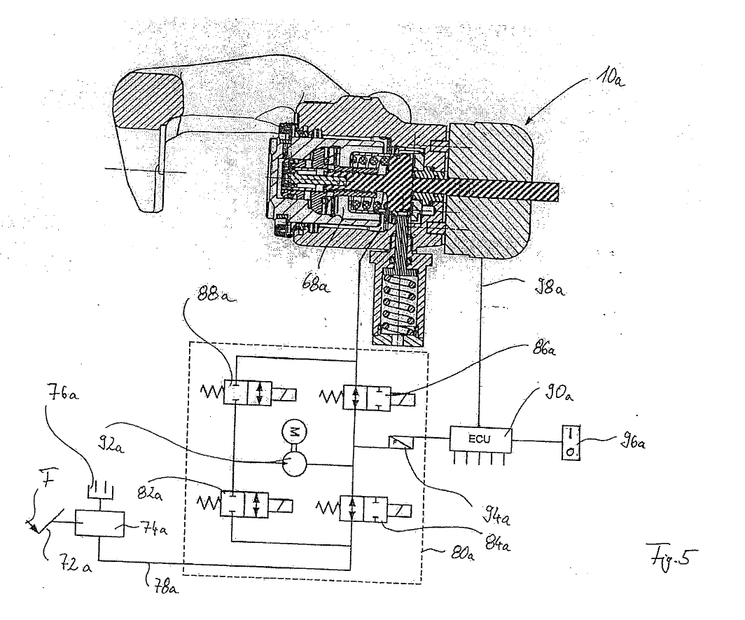

FIG. 5 shows a diagrammatic representation of the hydraulic system coupled to the vehicle brake 10a and of the components of the hydraulic system.

These are in particular a brake pedal 72a that interacts with a brake booster master cylinder unit 74a. In response to an actuating force F exerted on the brake pedal hydraulic fluid is fed from a reservoir 76a through a pressure line 78a to a hydraulic system 80a, preferably an ABS/ESP system. This comprises control valves 82a, 84a, 86a, 88a, which are controllable by means of an electronic control unit 90a. The hydraulic system further comprises a motor-driven pressure pump 92a, which is likewise coupled to the electronic control unit 90a. A pressure sensor 94a may moreover be provided for acquiring the hydraulic pressure introduced into the fluid chamber 68a in the open state of the control valve 86a. If a pressure sensor is not provided, for example for reasons of cost, the hydraulic pressure introduced into the fluid chamber 68a may be determined from a mathematical model. The electronic control unit 90a may be activated by means of a parking brake actuating switch 96a and is connected by a connection line 98a to the rotary magnet arrangement 42 according to FIG. 1 for activation thereof and for tapping the previously described parameters for function monitoring purposes, namely the actual rotary position and the power consumption of the electromagnet 42a.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. Vehicle brake comprising
a housing,
a brake piston accommodated in the housing and coupled to a brake lining,
a blocking device for arresting the brake piston inside the housing and
an electromechanical actuating device for activating the blocking device in a parking brake situation,
wherein the brake piston together with the housing delimits a fluid chamber that is chargeable with hydraulic fluid, so that the brake piston for actuating the vehicle brake is hydraulically displaceable inside the housing along a piston longitudinal axis,
wherein there is associated with the blocking device a locking arrangement, which in a parking brake situation acts positively on a component of the blocking device and locks the blocking device against a resetting movement.

2. Vehicle brake according to claim 1, wherein the blocking device comprises a transmission element, which is displaceable relative to the housing and relieves the blocking device upon actuation thereof relative to a fluid pressure prevailing inside the fluid chamber, wherein the transmission element has at least one hydraulically active pressure relief surface that is pressurized with hydraulic fluid from the fluid chamber.

3. Vehicle brake according to claim 2, wherein the transmission element is pressurized at least indirectly on both sides of its, in terms of a displacement in the fluid chamber, hydraulically active surfaces with hydraulic fluid from the fluid chamber.

4. Vehicle brake according to claim 1,
wherein the actuating device is motor-drivable or motor-driven by a rotary drive.

5. Vehicle brake according to claim 4, wherein the drive takes the form of a rotary electromagnet, the actual position or/and power consumption of which is tappable as information about the function state of the vehicle brake in a parking brake situation.

6. Vehicle brake according to claim 1,
further including a blocking element that acts on the brake piston for the arresting thereof, wherein the blocking element is drive-connected to the brake piston.

7. Vehicle brake according to claim 6,
wherein the blocking device comprises a ramp arrangement, wherein the ramp arrangement comprises at least one first ramp surface, which is provided on the housing or is coupled in a rotationally fixed manner thereto, and at least one second ramp surface, which is formed on a ramp component that is axially displaceable relative to the housing and coupled to the blocking element, wherein upon actuation of the actuating device the two ramp surfaces slide off one another in order to displace the blocking element.

8. Vehicle brake according to claim 7, wherein the ramp component is coupled to the transmission element and displaceable in a pressure-relieved manner inside the fluid chamber by means of the transmission element.

9. Vehicle brake according to claim 7, wherein the locking arrangement is designed with a locking organ that may be brought into interaction with the ramp component.

10. Vehicle brake according to claim 9, wherein the locking organ is biased by means of a biasing spring into the fluid chamber towards the ramp component in a locking position and by virtue of sufficient pressurization upon charging of the fluid chamber with hydraulic fluid is displaceable out of the locking position into a release position when a minimum pressure value is exceeded.

11. Vehicle brake according to claim 9, wherein the locking organ is biased by means of a magnet arrangement into the fluid chamber towards the ramp component in a locking position and by virtue of actuation of the magnet is displaceable out of the locking position into a release position.

12. Vehicle brake according to claim 9, wherein the locking organ takes the form of a catch element that may be brought with a locking profile into engagement with a complementary locking profile of the ramp component.

13. Vehicle brake according to claim 12, wherein the locking profile comprises at least one detent tooth and that the complementary locking profile comprises a corresponding saw-tooth formation that is disposed preferably on a circumferential surface of the ramp component.

14. Vehicle brake according to claim 1, wherein in a service brake situation the brake piston is displaceable inside the housing by charging the fluid chamber with hydraulic fluid and emptying the fluid chamber and that in a parking brake situation first the brake piston is displaced inside the housing by charging the fluid chamber with hydraulic fluid, then the electromechanical actuating device is actuated to arrest the brake piston, wherein the transmission element moves towards the brake piston, then the locking arrangement is activated and finally for a pressure reduction in the fluid chamber hydraulic fluid is removed from the fluid chamber, wherein for cancelling the parking brake situation the fluid chamber is charged with hydraulic fluid, then the blocking device and the locking arrangement is released and finally for a pressure reduction in the fluid chamber hydraulic fluid is removed from the fluid chamber.

15. Method of actuating a vehicle brake according to claim 1,
wherein in a service brake situation the brake piston is displaced inside the housing in that hydraulic fluid is fed to or removed from the fluid chamber, and that in a parking brake situation first the brake piston is displaced inside the housing by charging the fluid chamber with hydraulic fluid, then the electromechanical actuating device is actuated to arrest the brake piston, wherein the transmission element moves towards the brake piston, then the locking arrangement is activated, and finally for a pressure reduction in the fluid chamber hydraulic fluid is removed from the fluid chamber, wherein for cancelling the parking brake situation the fluid chamber is charged with hydraulic fluid, then the blocking device and the locking arrangement are released and finally for a pressure reduction in the fluid chamber hydraulic fluid is removed from the fluid chamber.
